(19) United States
(12) Patent Application Publication
(10) Pub. No.: US 2024/0223969 A1
(43) Pub. Date: Jul. 4, 2024

(54) ROLL-TO-ROLL MICRO-SCALE THERMAL WIRE MICROPHONE

(71) Applicant: NIKON CORPORATION, Tokyo (JP)

(72) Inventor: Fardad Ali HASHEMI, Menlo Park, CA (US)

(73) Assignee: NIKON CORPORATION, Tokyo (JP)

(21) Appl. No.: 18/405,434

(22) Filed: Jan. 5, 2024

Related U.S. Application Data
(63) Continuation of application No. PCT/US2022/036224, filed on Jul. 6, 2022.
(60) Provisional application No. 63/219,317, filed on Jul. 7, 2021.

(51) Int. Cl. H04R 23/00; H05B 3/06

(52) U.S. Cl. CPC H04R 23/002; H05B 3/06; H05B 2203/003

(57) ABSTRACT

Micro-wire sensors comprise a conductive sensing element situated above a substrate. The sensing element can be fixed to the substrate at one or more ends and can be formed by patterning a conductive layer deposited on a flexible or other substrate. Conductive connecting pads and bias resistors can be formed with the sensing element in a common conductive layer.

### CROSS-REFERENCE TO RELATED APPLICATIONS

This application claims the benefit of U.S. Provisional Application 63/219,317, filed Jul. 7, 2021, which is incorporated herein by reference. The present application is a continuation application of International Application PCT/US2022/036224, filed on Jul. 6, 2022. The contents of the above application are incorporated herein.

### BACKGROUND

### Technical Field

The disclosure pertains to thermal microphones.

### Description of Related Art

So-called “hot-wire” microphones use a heated wire that can be placed at the output of a Helmholtz resonator so that air flow produced by sound at the resonator cools the heated wire. The cooling produces a change in resistance of the hot wire that can be detected and amplified. Such a microphone is described in Tucker, et al, “A selective hot-wire microphone,” Phil. Trans. Royal Society A, January 1921, pages 389-430, which is incorporated herein by reference. This microphone is useful at a single low frequency since the resonance frequency of the Helmholtz resonator is typically low. In addition, the heated wire is large and the time constant for cooling is long so that the hot-wire microphone is not useful for high frequency applications. Such heated wires can also be used in anemometers and other applications but are limited to low frequency applications. Approaches are needed that provide high frequency response and permit fabrication of multiple devices on rigid or flexible substrates.

### SUMMARY

The disclosure pertains to sensors that include a sensing element such as a portion of a conductive layer that is spaced apart from a substrate. The sensing element is typically heated or set to a predetermined temperature different from an ambient temperature so that vibration of the sensing element cools or heats the sensing element, changing sensor element electrical conductivity. With such a sensor, acoustic waves or disturbances can be detected and quantified.

The sensing elements can be portions of conducive layers formed on rigid or flexible substrates, including substrates provided in rolls. Substrate/sensing element gaps can be selected to provide suitable response and gaps can be in range of 100 nm to 10 μm or other range. Typically sensing elements have portions that have larger vibration amplitudes in response to vibrational inputs such as acoustic signals and sensing element resistance is generally selected to be relatively large in these portions. Methods of fabrication such sensors are also disclosed.

In some examples, sensors comprise a substrate and a sensing element secured to the substrate at least one end so that the sensing element is spaced apart from the substrate. A sensor circuit is coupled to the sensing element and operable to heat the sensing element and produce an output signal associated with vibrations of the sensing element. Typically, the output signal associated with vibrations of the sensing element corresponds to changes in temperature of the sensing element. In some examples, the sensing element is secured to the substrate at a first end and a second end so that the sensing element extends from the first end to the second end and is suspended from the substrate. In representative examples, a spacer is situated at the at least one end of the sensing element to define a gap between the sensing element and the substrate. In some cases, the substrate is a flexible substrate such as polyethylene terephthalate. Typically, the sensing element is a metal. In further examples, a resistive conductor is coupled to the sensing element, wherein the sensor circuit is operable to heat the sensing element with a current conducted by the resistive conductor to the sensing element. At least one conductive pad can be defined on the substrate, wherein the conductive pad and the sensing element are defined in a common conductive layer. In some cases, the at least one conductive pad comprises first, second, and intermediate conductive pads, and a resistor is defined in the common conductive layer, and the sensing element is coupled to the first conductive pad by the resistor and fixed to the substrate at the second conductive pad. A spacer can be situated between the first conductive pad, the second conductive pad, the intermediate conductive pad, and the resistor, wherein the sensing element is spaced apart from the substrate by the spacer, typically wherein a portion of a spacer perimeter contacts the spacer. According to one example, the resistor comprises a serpentine strip defined in the common conductive layer. In some examples, an enclosure is situated about at least the sensing element and the enclosure is filled with an inert gas.

Representative methods comprise forming a conductive layer coupled to a substrate and patterning the conductive layer to define a conductive sensing element spaced apart from the substrate, wherein a first fixed end and a second fixed end of the conductive sensing element are secured to the substrate. The conductive layer can be formed on a spacer layer, and the conductive sensing element is spaced-apart from the substrate by removing a portion of the spacer layer. The spacer layer can be formed on the substrate at a location associated with the conductive sensing element, wherein the conductive layer is formed on an exposed portion of the substrate and the spacer layer followed by removing the spacer layer so that the conductive sensing element is spaced-apart from the substrate. A resistor can be defined in the conductive layer, wherein the resistor is operable to heat the conductive sensing element. In some cases, the resistor is defined as a serpentine conductive strip. The conductive sensing element can include a plurality of segments that are symmetric about an axis.

In other examples, sensor arrays comprise a substrate and a plurality of sensors defined on the substrate. Each of the plurality of sensors can include a sensing element and at least one spacer coupled to the sensing element and the substrate to define a gap between the sensing element and the substrate. The sensing element and the at least one spacer of each of the sensing elements can be defined in a common conductive layer and a common spacer later, respectively. Each sensor can further include first, second, and intermediate conductive pads defined in the common conductive layer and coupled to the sensing element and a resistor defined in the common conductive layer and coupled to the sensing element and a selected one of the first, second, and intermediate conductive pads. In some examples, the substrate is a flexible substrate. At least some of the resistors and at least some sensing elements can have different shapes.

The foregoing and other features, and advantages of the disclosed technology will become more apparent from the following detailed description, which proceeds with reference to the accompanying figures.

### BRIEF DESCRIPTION OF THE DRAWINGS

FIGS. 1A-1B illustrate a sensor defined on a flexible substrate and having a linear resistor.

FIGS. 1B1-1B2 illustrate vibrational modes of a sensing element included in the sensor of FIGS. 1A-1B showing a 1.7 kHz symmetric mode and a 1.8 kHz asymmetric mode, respectively

FIGS. 1C-1D illustrate additional sensors using the sensing element of FIGS. 1A-2B but with different resistor conductors.

FIG. 1E illustrates a representative system that includes a suspended sensing element.

FIGS. 2A-2C illustrate representative cantilevered sensing elements.

FIGS. 2D-2F illustrate representative vibrational modes of the sensing element of FIG. 2C.

FIG. 2G illustrates another suspended sensing element.

FIG. 3 illustrates a sensor configuration with a cantilevered sensor element.

FIG. 4 illustrates another representative sensor configuration.

FIGS. 4A-4B are sectional views of the sensor configuration of FIG. 4.

FIG. 5 illustrates an arrangement of different sensors.

FIG. 6A illustrates a method of fabricating sensors.

FIGS. 6B-6E illustrate sensor fabrication according to one approach.

FIG. 7A illustrates an arrangement of different sensors on a single substrate.

FIG. 7B illustrates a sensor system that includes a sensor array.

FIG. 8A illustrates a sensor having a serpentine resistor.

FIG. 8B illustrates a sensor having a sensing element and contact pads of different materials.

FIG. 9A illustrates a representative sensor system.

FIG. 9B illustrates sensor sensitivity as a function of bias voltage (sensing element temperature).

FIG. 9C corresponds to FIG. 9B but normalized based on bias voltage.

FIG. 9D illustrates sensor frequency response for a range of sensing element to substrate gaps.

FIGS. 10A-10D illustrate representative sensing elements.

FIG. 10DD illustrates a vibrational mode of the sensor of FIG. 10D.

FIGS. 10F-10F illustrate additional representative sensing elements.

FIGS. 11A-11C illustrate a method of fabricating sensors.

FIGS. 12A-12C illustrate a method of fabricating sensors.

FIGS. 13A-13C illustrate another method of fabricating sensors.

FIGS. 14A-14B illustrate a cantilevered sensor element.

FIG. 15A-15B illustrate a sensor formed in a sheet of sensors, each sensor situated in a hermetic container.

FIG. 16 illustrates a geometry for estimation of a minimum radius of curvature of a sensor.

FIGS. 17A-17B illustrate a representative sensing element geometry and a nonlinear response of such a sensing element, respectively.

### DESCRIPTION OF THE EMBODIMENTS

### Introduction and Terminology

Disclosed herein are micro-wire sensors and associated methods and systems based on sensing elements that can have multiple resonance modes and resonance frequencies and low thermal mass. The disclosed approaches also permit fabrication with flexible or rigid substrates so that large arrays of devices can be formed, and sheets of such sensors can be provided for applications that require sensing at multiple locations or over large areas. The resonance modes exhibit low Q so that wide band resonances can overlap, allowing for sound measurements at frequencies and in frequency ranges for which conventional approaches are unsuitable. As used herein, “Q” refers to a ratio of a device resonance frequency to device bandwidth (full width at half maximum). The disclosed sensor examples are generally based on a relatively narrow and thin strip of sensor material, generally a conductor such as gold, copper, aluminum, indium tin oxide or other conductor or semiconductor material that is suspended above a rigid or flexible substrate and fixed with respect to the substrate at one or more places. As used herein, a suspended conductor (or other sensor material) such as a conductive strip is referred to as a sensing element or sensing conductor. Such a sensing element may be in the form of an elongated strip, a strip that follows a serpentine path or a spiral path or can be U-shaped or plate-shaped with or without grooves or slots in the plates or follow a linear or non-linear path. Sensing elements can be formed of a common conductive layer used to form conductive pads for electrical connections and conductive strips used to define resistors that connect to the sensing element, but other configurations can be used. Sensing elements can be suspended or cantilevered at one or more fixed points. In one approach, suspension is achieved by removing an underlying sacrificial layer. In some disclosed examples, a combination of very small thermal mass due to thin metal layers and high thermal conduction due to small conduction gaps between the sensing element and the substrate permits fast response times.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present, or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

### Example 1

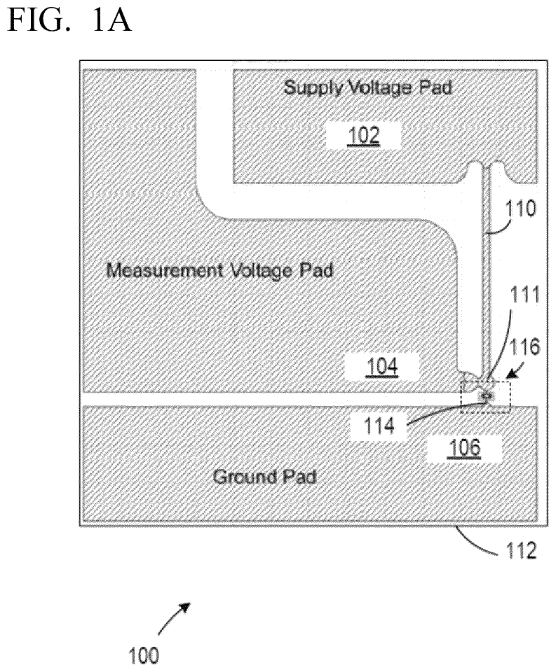

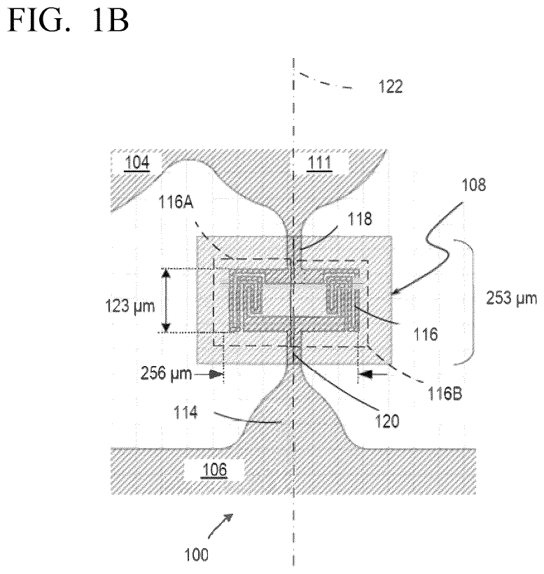

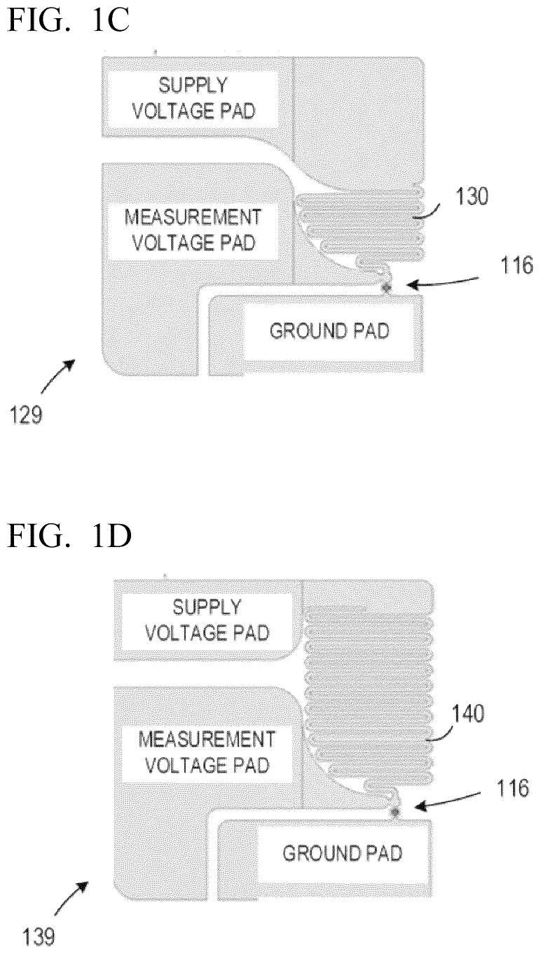

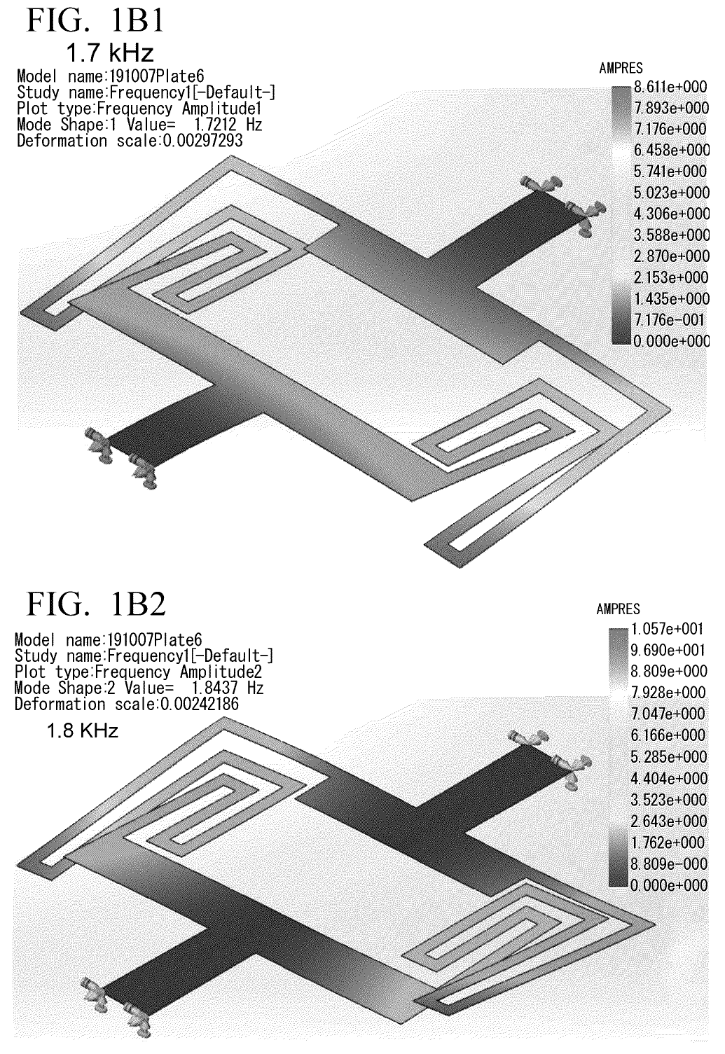

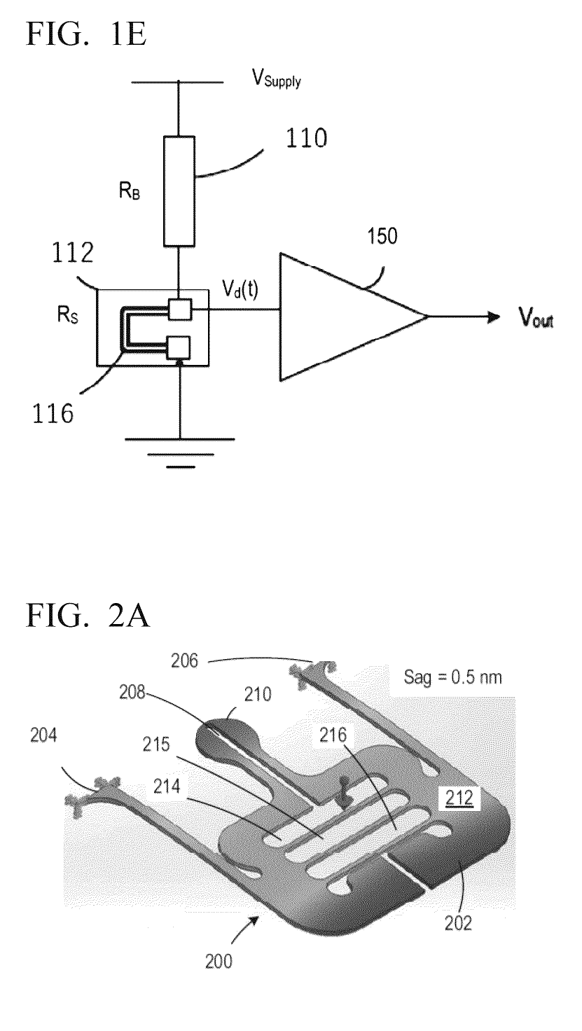

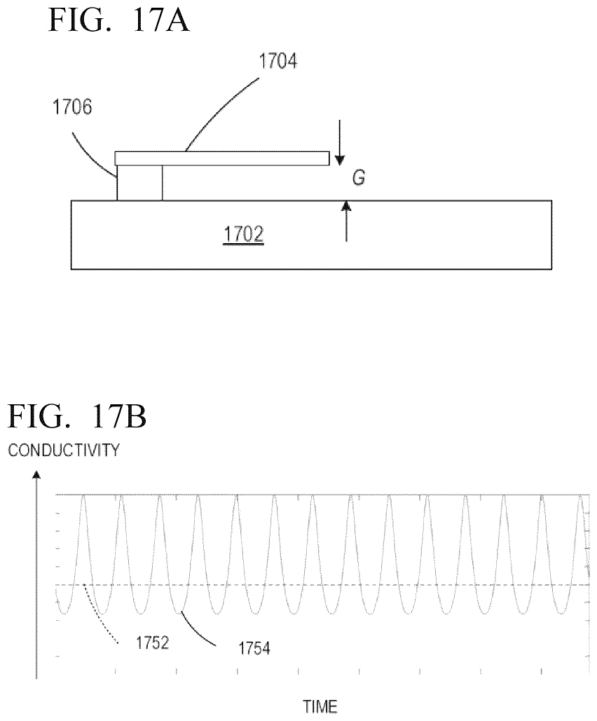

Referring to FIGS. 1A-1B, a sensor 100 includes conductive pads 102, 104, 106 situated on a substrate 112. In FIG. 1A, the pads are referred to as a supply voltage pad, a measurement voltage pad, and a ground pad, respectively, for convenient description of a representative circuit arrangement for use with the sensor 100 but other electrical connections can be used. A resistor element 110 extends from the pad 102 to electrically connect to the pad 104 at a conductive connection 111. A sensing element 116 includes a first end 118 that is electrically coupled to the conductive connection 111 and a second end 120 that is electrically coupled to a coupling region 114 of the third pad 106. The sensing element 116 is spaced apart from the substrate 112 in a region 108 (that can be established using a sacrificial layer in fabrication) and the first end 118 and the second end 120 are fixed to the substrate 112. Vibration or other motion of the sensing element 116 with respect to the substrate 112 that varies a gap between the sensing element 116 and the substrate 112 also varies a thermal conductivity between the sensing element 116 and the substrate 112. With the sensing element 116 heated (or cooled), such variations in thermal conductivity vary sensing element cooling (or heating) rate and sensing element temperature. The associated variations in electrical resistance are associated with sensing element vibration or motion. This is described in detail below (see FIGS. 17A-17B).

In this example, the sensing element 116 includes first and second interdigitated sets of segments 116A, 116B that are symmetric about an axis 122 that extends along the first end 118 and the second end 120. The resistor element 110 (i.e., the resistance) is selected such that the temperature of the sensing element 116 can be established as needed. In some cases, the sensing element 116 is defined by depositing a conductive layer on a sacrificial layer (such as a photoresist) in the region 108 and then removing the sacrificial layer. In FIGS. 1A-1B, a sacrificial layer is shown only at the region 108 but can be provided underneath the pads 102, 104, 106 the resistor element 110, and the conductive connection 111. This portion is typically removed to suspend the sensing element and is shown in only for purposes of illustration. The sensing element 116 is spaced above the substrate 112 and is responsive to acoustic signals over a wide frequency range. The sensing element 116 can be heated with an electrical current supplied via the resistor element 110. Because heat transfer from the sensing element 116 depends on the spacing from the substrate 112 established by the sacrificial layer, any vibration or other motion of the sensing element 116 (or any of the segments 116A, 116B) tends to modulate heat transfer from and the temperature of the sensing element 116. These temperature changes produce changes in the electrical resistivity of the sensing element 116 that can be detected.

In typical examples, the gap between the sensing element 116 and the substrate 112 is between 0.2 and 20 μm, 0.2 μm and 10 μm, 0.5 and 10 μm, 1 and 5 μm, 1 and 3.5 μm, or other ranges and thermal resistance between the sensing element 116 and the substrate 112 permits cooling. The sensing element 116 has low mass—the conductive layer used to form the sensing element 116 can be thin (for example, between 0.1 μm and 25 μm) and the total area of the sensing element 116 can be small (for example, between 1 mm² and 10 mm²) so the thermal mass of the sensing element can be small as well. In some cases, the gap between the sensing element 116 and the substrate 112 is determined by sensing element sag. The gap is sufficiently large to prevent the sensing element from contacting the substrate but otherwise is made small. For an estimated sag S, a gap can be set as 1.1 S, 1.2 S, 1.3 S, 1.4 S, 1.5 S, 1.75 S, 2 S, 2.5 S, 3 S or any other value greater than S, with smaller gaps being associated with superior sensor response. In the example of FIGS. 1A-1B, the gap is 1 μm, design supply voltage is 1 V and target operating temperature is 100° C.

Typically, sensing elements are designed to keep sag small. In most applications, sensing orientation relative to gravity remains constant and any sag-related effects are constant. Sag (including constant sag expected at a fixed orientation) can be used in selected a sensing element gap, but in many practical examples, such consideration is unnecessary. Generally a small (or minimum) gap is selected to improve electro-thermal response, but gap can also be selected in view of fabrication capabilities, minimum radius of the rolled up substrate during shipping and storage, and thin film damping and its effect on the mechanical response.

Approximate dimensions for a representative example are shown in FIG. 1B. A suspended area is about 253 μm long. A lowest order mode frequency for a symmetric mode (or an asymmetric mode) is between about 1.7 to 1.8 kHz. FIGS. 1B1-1B2 illustrate representative symmetric and asymmetric modes, respectively. Satisfactory response should extent to at least to 5 kHz and a typical frequency range is 1.5 kHz to 5 kHz. In some applications, a supply voltage is applied to the pad 102 to produce a current that can heat the resistor element 110 and/or the sensing element 116. Changes in electrical resistance associated with movement produce corresponding voltage changes at the pad 104 which can be coupled to an amplifier or other analog or digital circuitry to produce a corresponding output signal. For example, referring to the electrical schematic in FIG. 1E, an amplifier 150 is coupled to receive a signal produced by variation of the resistance R_{S}(t) of the sensing element 116. R_{S}(t) is a function of time due to resistance variation produced by sensor element motion and the associated heating and cooling. A supply voltage V_{S} is applied to a series resistance that is the sum of R_{S}(t) and a resistance R_{B} of the resistor element 110 so that an input voltage to the amplifier 150 is

$${V}_{d} ( t ) = {V}_{Supply} \frac{{R}_{s}}{{R}_{s} + {R}_{B}} .$$

In other examples a current can be sensed instead of a voltage. If a current source provides a fixed current I, a sensor output single can be proportional to IR_{S}(t). In any application, a signal from the sensor can be digitized with an analog-to-digital convertor. Thus, as R_{S}(t) changes in response to temperature changes due to motion such as resonant motion of the sensor element 116 due to acoustic waves, R_{S}(t), V_{d}(t) or Vₒᵤₜ(t) can be detected to detect the acoustic waves.

Vs can be any convenient voltage such as any voltage between, 0 and 20 V and voltages of 1, 2, 3, and 4 V can be used. R_{B} can have a very large range depending on an intended R_{B}/R_{S} ratio and the intended supply voltage. For a resistance ratio of 99:1 and supply voltage between 2V and 15 V the values of R_{B} for the given target temperatures for the sensing element in one example are given in following Table:

| Tₛₑₙₛₒᵣ (° C.) | R_{B} (Ω) |
|---|---|
| 50 | 9.217324587 |
| 100 | 10.75618015 |
| 150 | 12.33260267 |
| 200 | 13.94659215 |
| 250 | 15.59814861 |
| 300 | 17.28727202 |
| 350 | 19.0139624 |
| 400 | 20.77821974 |

At the other extreme, for a resistance ratio of 1:1 and supply voltage of less than 1V, representative values of R_{B} are given in following Table:

| Tₛₑₙₛₒᵣ (° C.) | R_{B} (Ω) |
|---|---|
| 50 | 0.093104289 |
| 100 | 0.108648284 |
| 150 | 0.124571744 |
| 200 | 0.140874668 |
| 250 | 0.157557057 |
| 300 | 0.174618909 |
| 350 | 0.192060226 |
| 400 | 0.209881008 |

A nominal sensor resistance R_{S} is determined by the target nominal temperature in the absence of sound or mechanical excitation and in this example is as follows:

| Tₛₑₙₛₒᵣ (° C.) | R_{B} (Ω) |
|---|---|
| 50 | 0.093104289 |
| 100 | 0.108648284 |
| 150 | 0.124571744 |
| 200 | 0.140874668 |
| 250 | 0.157557057 |
| 300 | 0.174618909 |
| 350 | 0.192060226 |
| 400 | 0.209881008 |

The substrate 112 can be a flexible roll material such as a plastic roll material (for example polyethylene terephthalate (PET)), or a rigid material such as glass. Conductors can be formed of copper, aluminum, indium tin oxide, or other conductors, semiconductors, or insulators having electrical resistivities that are suitably temperature dependent. While it is convenient to make the conductors, pads, resistors, and sensor element of a common layer, different materials can be used for each. For example, sensor elements preferably have high heat resistance, are durable, and have resistances that vary with temperature. The conductive pads 102, 104, 06 preferably have low resistivity. Therefore, the materials of the sensor element and the conductive pads 102, 104, and 106 can be different

A single spacer layer can be used but multiple spacers and/or spacer layers can be used to space sensing elements from a substrate. In some examples discussed below, suspended sensing elements are bridged. Conductor portions that are coupled to sensing elements can be spaced apart from substrates but sufficiently wide or otherwise made rigid so that sensing elements do not exhibit excessive sag towards a substrate. The design/shape of a sensing element can be selected to provide a primary mode of resonance at a lowest frequency in a desired range of detection or at a primary frequency desired for detection at a single ultra-sound or other sound frequency based on the intended applications.

FIGS. 1C-1D illustrate sensors 129, 139 having different resistor elements 130, 140 used with the sensing element 116. Different resistor elements can be used to, for example, establish different temperatures for the sensing element 116. In the example of FIG. 1C, the gap is 1 μm, design supply voltage is 3 V and target operating temperature is 400° C. In the example of FIG. 1D, the gap is 1 μm, design supply voltage is 5 V and target operating temperature is 200° C.

### Example 2

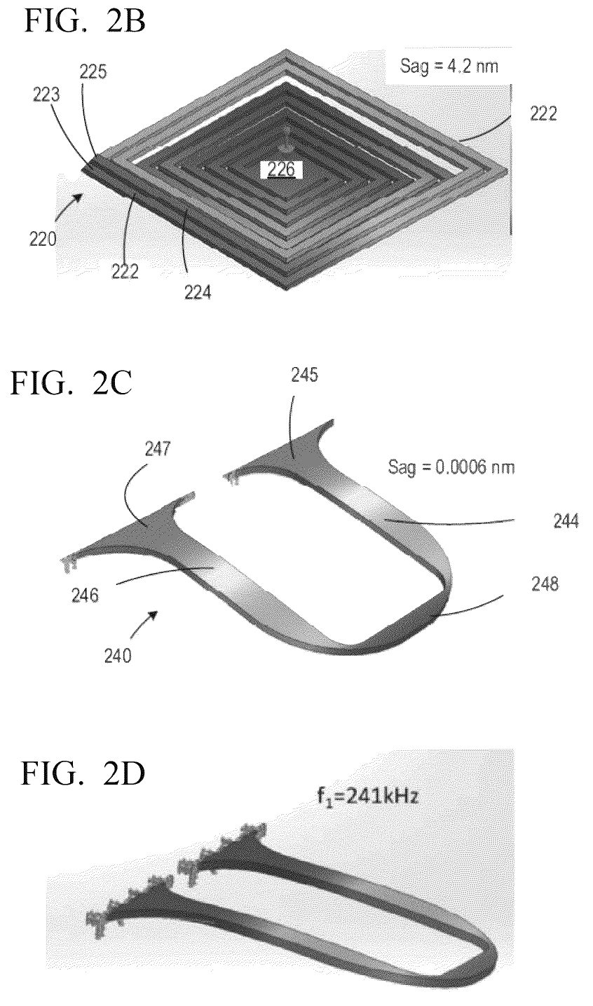

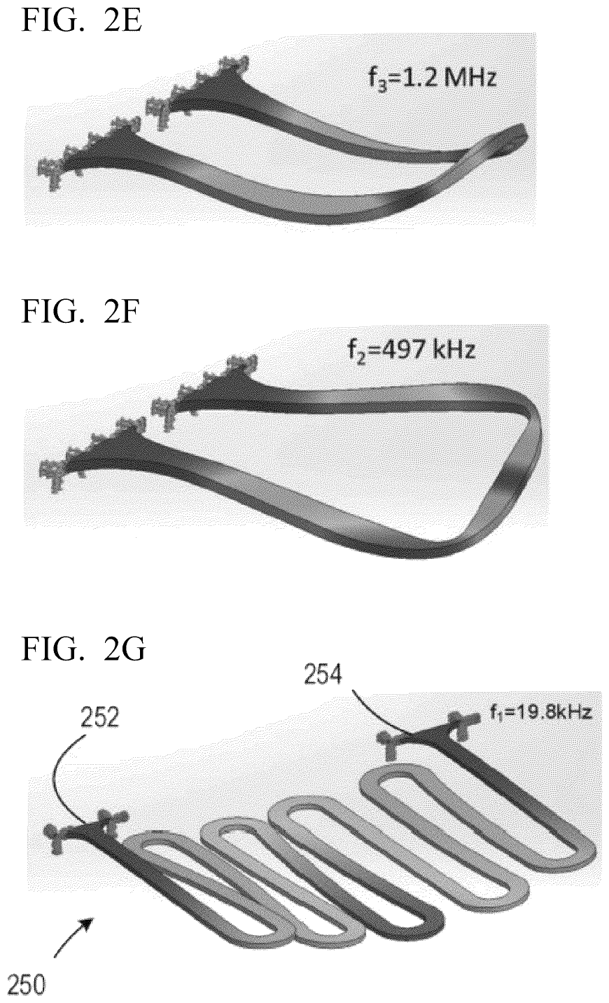

FIGS. 2A-2C illustrate representative sensing elements. The sensors in FIGS. 2A-2C have varying shapes and sizes. The shape and the size of the sensor is determined based on a target frequency to be detected. Referring to FIG. 2A, a conductive sensing element 200 includes a metallic sheet 202 that is fixed to conductive pads (not shown) at fixed ends 204, 206 and is suspended with respect to a substrate (not shown). A slot 208 is formed on a tab 210 that extends from an area 212 on which slots 214-216 are formed. The slots 214-216 extend perpendicularly with respect to the slot 208 so that the sensing element 200 is symmetric about the slot 208. In typical applications, the fixed ends 204, 206 are coupled to an amplifier or other circuitry that provides an output signal associated with vibration of the sensing element 200 or portions thereof and a power supply that provides a suitable bias for sensing and for heating the sensing element 200. In one example, such a sensing element exhibits a sag due to suspension of no more than about 0.5 nm so that sensing element/substrate gaps greater than 10 nm, 50 nm, 100 nm, 200 nm, 500 nm, 1 μm or more can be used without the sensor contacting a substrate. Any gap greater than the sensing element sag can be used. In the example of FIG. 2A, a resonant frequency of a lowest order mode is 26.4 kHz. In this example, the target gap is 1 μm and the size of the sensing element is 116 μm by 116 μm. A useful frequency range extends from 26 kHz (1st mode) to 227 kHz (a 5th mode of a type associated with cooling). This example is typically intended for use in conditions where a transducer attached to an object to be located is emitting sound at one of 4 of the first 5 mode frequencies of 26 kHz, 80 KHz, 163 kHz, or 227 kHz. A third mode of the first 5 mode frequencies is not well suited for sensing as it is not associated with sufficient out of plane motion (i.e., with respect to the substrate) for cooling and other modes are preferable.

FIG. 2B illustrates a representative conductive sensing element 220 that includes interleaved square spiral conductors 222, 224 having fixed ends 223, 225, respectively. The square spiral conductors 222, 224 terminate at a central conductive area 226. The fixed ends 223, 225 are typically fixed to conductive pads and suspended with respect to a substrate. Other spirals can be used including arbitrary curved or polygon based spiral shapes. In one example, such a sensing element exhibits a sag due to suspension of no more than about 4.2 nm and a resonant frequency of a lowest order mode is 8.9 kHz. In this example, the target gap is 1 μm and the sensing element is 114 μm by 114 μm. A useful frequency range extends from 8 kHz (1st mode) to 55 kHz (a 5th mode of a type associated with cooling).

FIG. 2C illustrates a U-shaped conductive sensing element 240 that includes side portions 244, 246 having fixed ends 245, 247, respectively, and a bottom portion 248. The sensing element 240 generally is suspended with a spacer or is bridged to define a gap between the sensing element 240 and a substrate. In one example, such a sensing element exhibits a sag due to suspension of no more than about 0.006 nm. In the example of FIG. 2C, resonant frequencies include 241 kHz, 497 kHz, and 1.2 MHz. In this example, the target gap is 1 μm and the sensing element is about 150 μm by 150 μm. This sensor is intended for use in conditions where a transducer attached to an object to be located is emitting sound at one the first 3 mode frequencies of 241 kHz, 497 kHz, or 1.2 MHZ

Sensing elements such as shown above can be suitable for high frequency applications such as, for example, frequencies above 10 kHz, 250 kHz, 500 kHz, or 1 MHz. FIGS. 2D-2F illustrate representative low order vibrational modes of the sensing element of FIG. 2C at frequencies of 241 KHz, 1.2 MHz, and 497 kHz. Such sensing elements can be used to detect objects such as robots, for example, robotic vacuums, that have acoustic emissions at these high frequencies. Many of these sensors can be situated beneath flooring and used to detect guide robotic vacuums. In other examples, multiple such sensors are distributed throughout a surface or volume and used to detect and/or guide a robot. High frequency designs generally have higher stiffness to inertia ratios and thus exhibit less gravity sag. Designs can be selected based on a compromise between gravity sag and lower frequency operation.

FIG. 2G illustrates another sensing element 250 that is supported at ends 252, 254 and has a serpentine shape. In the example of FIG. 2G a resonant frequency of a lowest order mode can be about 19.8 kHz. In this example, the target gap is 1 μm and the sensing element is about 124 μm by 157 μm. One application of this example is in conditions in which a transducer attached to an object to be located is emitting sound at somewhere in the range of 19.8 kHz or 25 kHz. Because of its finger like structures, this sensing element has multiple modes near each other in frequency in that range.

### Example 3

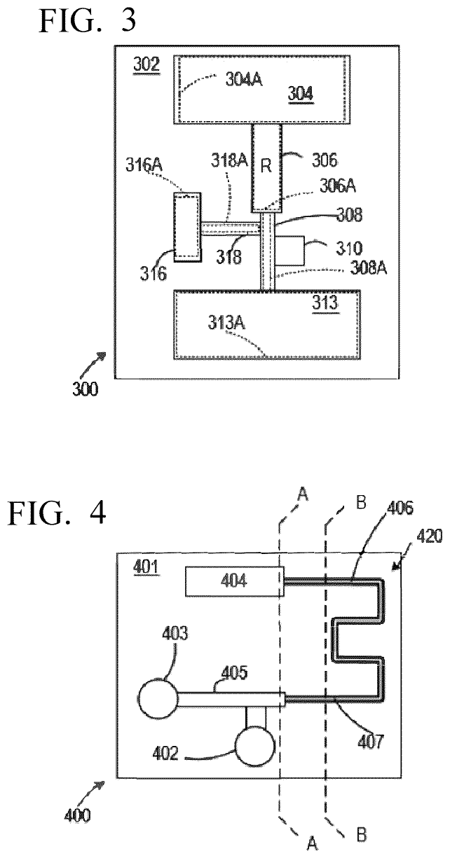

FIG. 3 schematically illustrates a sensor 300 that includes connectors such conductive pads 304, 313, 316 that are defined on a substrate 302. The conductive pad 304 is coupled to resistor 306 which can be defined in a conductive layer, such as a layer used to define some or all of the conductive pads 304, 313, 316, or a discrete resistor can be used. Conductive strips 308, 318 (or other conductors such as wires) couple the conductive pads 304, 313, 316 to a sensing element 310 such as those described above. The resistor 306 can be used to control heating of the sensing element 310 as well as establish a resistive divider network with the sensor so that voltage or current changes based on vibration of the sensor 310 are coupled to the conductive pad 316 for output to an amplifier, analog-to-digital convertor (ADC), or other processing circuitry. Vibration induced currents or voltages can be capacitively coupled for output as DC levels are associated with a stationary sensor and not acoustic signals to be detected. Portions 304A, 306A, 308A, 313A, 316A, 318A remain between the respective conductor portions and the substrate 302 while the sensing element 310 is suspended from the substrate 302

### Example 4

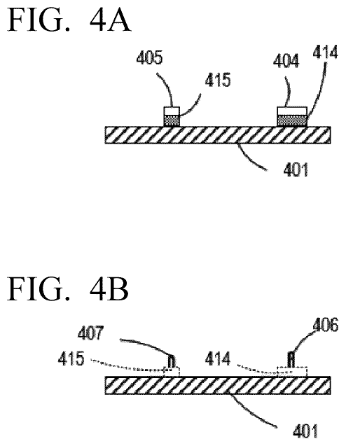

FIG. 4 schematically illustrates a sensor 400 that includes connectors such conductive pads 402-404 that are defined on a substrate 401. A sensing element 420 is coupled to the conductive pad 404 and a conductive strip 405 that can serve as a resistor. The conductive pad 402 is coupled to the conductive strip 405 proximate the sensing element 420. The conductive strip 405 and the sensing element 420 form a voltage divider which can produce a sensor output signal at the conductive pad 402 in response to vibration of the sensing element 420. An additional conductive pad 402 can be provided as well.

FIGS. 4A-4B are sectional views of FIG. 4. In FIG. 4A, the conductive strip 405 is situated on a spacer 415 that can be defined in a spacer layer of photoresist or other material. The conductive pad 404 is situated on a spacer 414 that can be defined in a spacer layer of photoresist or other material. The spacers 414, 415 separate conductive pad 404 and the conductive strip 405 from the substrate 401 and it can be convenient to define the spacers 414, 415 in a common layer such as a common layer of photoresist. As shown in FIG. 4B, a first end 406 and a second end 407 of the sensing element 420 are situated above the substrate 401. While the spacers 414, 415 do not extend to be under the sensing element 420, the spacers 414, 415 are shown in outline showing that they serve to space the sensing element 420 above the substrate 401.

### Example 5

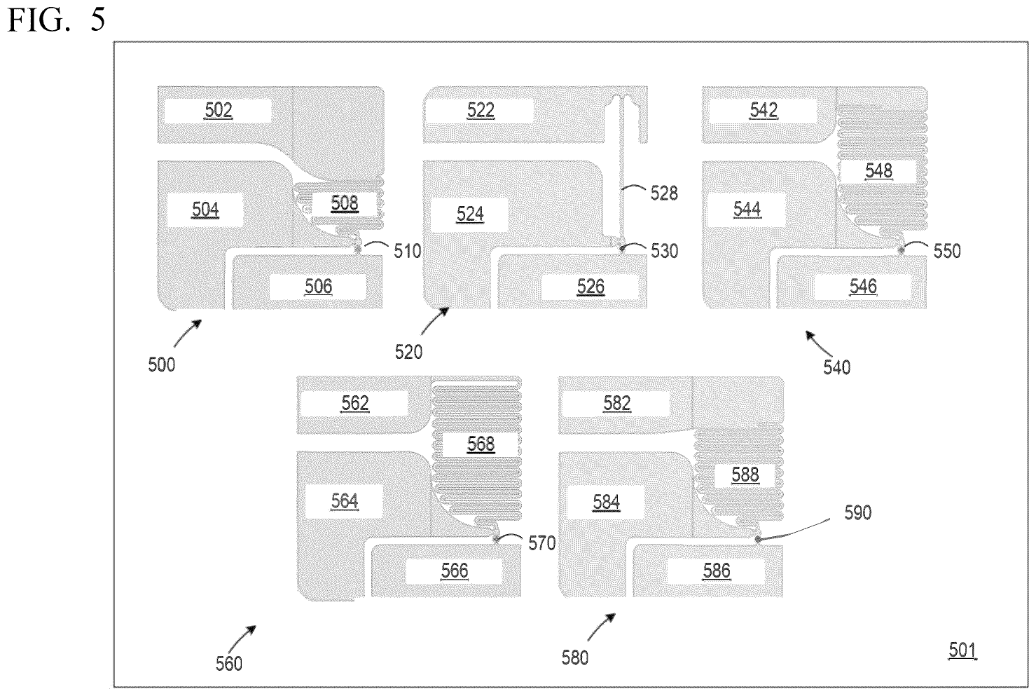

Referring to FIG. 5, sensors 500, 520, 540, 560, 580 are defined on a common substrate 501 such as a rigid or flexible substrate. These sensors can be produced using common layers and common processing steps and can be patterned to be the same or different. As shown, the sensor 500 includes conductive pads 502, 504, 506, a serpentine conductive strip 508 that can serve as a resistor, and a sensing element 510. The sensor 520 includes conductive pads 522, 524, 526, a linear conductive strip 528 that can serve as a resistor, and a sensing element 530. The sensor 540 includes conductive pads 542, 544, 546, a serpentine conductive strip 548 that can serve as a resistor, and a sensing element 550. The sensor 560 includes conductive pads 562, 564, 566, a serpentine conductive strip 568 that can serve as a resistor, and a sensing element 570. The sensor 580 includes conductive pads 582, 584, 586, a serpentine conductive strip 588 that can serve as a resistor, and a sensing element 590. In the example of FIG. 5, the conductive strips provided to serve as resistors all have different shapes and/or sizes. In some applications, a sensor operating temperature is established based on the resistance of a conductive strip and selection of a particular shape and size of conductive strip permits selection of resistance. It can be convenient to use a readily available voltage or current source to provide heating and selection of conductive strip can be used to accommodate any convenient electrical source and to permit multiple different sensors to be thermally biased with the same current or voltage. In other examples, some or all of these conductive strips can have the same configuration. The associated resistances can be the same or different. Some or all of the sensing elements can also be the same or different. As discussed above, the sensing elements include portions that are fixed and portions that are spaced apart from the substrate 501.

### Example 6

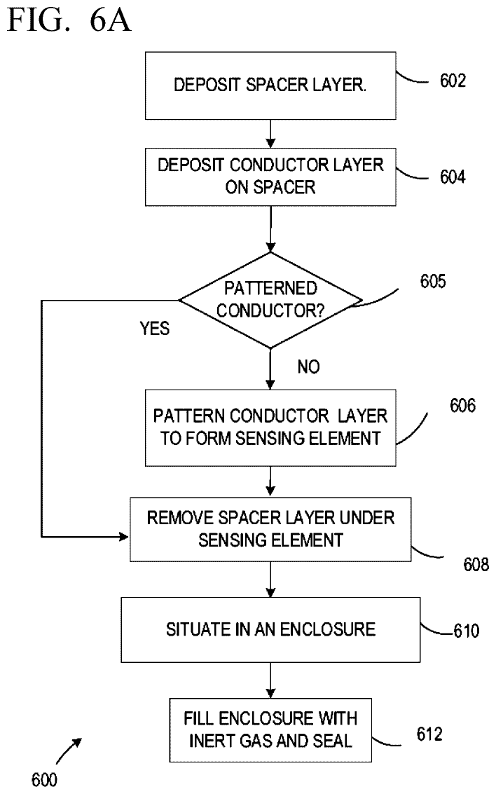

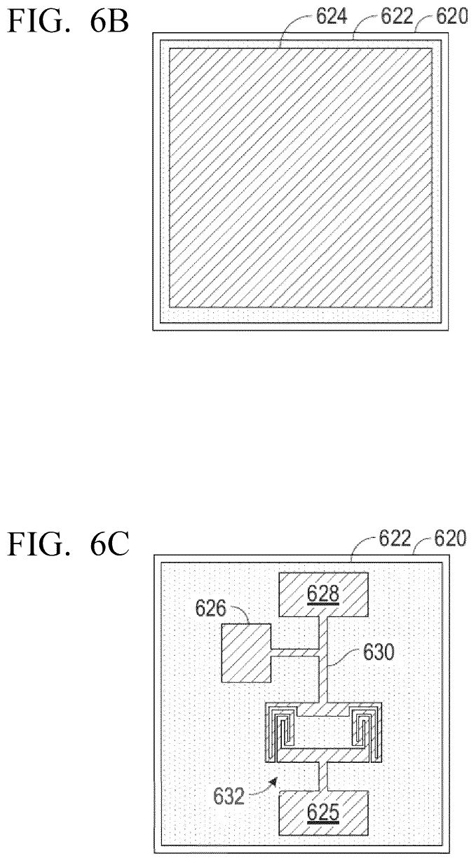

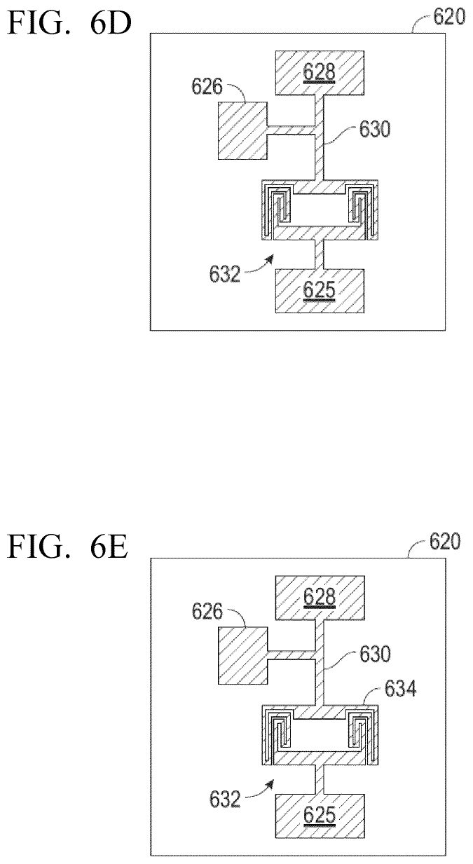

Referring to FIGS. 6A-6E, a representative method 600 includes forming a spacer layer 622 on a substrate 620 at 602. The substrate 620 can be rigid or flexible, and can be provided as a sheet, wafer, plate, in a roll, or otherwise provided. Representative substrate materials include glasses and plastics, including plastics received in a roll. The spacer layer 622 can be an insulator, conductor, or semiconductor, and is typically selected to permit selective removal as discussed below. In some cases, the spacer layer 622 is a photoresist or other insulative layer and is applied to the substrate by spin coating, spraying, slot die coating, lamination, or other approach. At 604, a conductor layer 624 is formed on the spacer layer 622 by, for example, lamination, sputtering, plating, e-beam evaporation, or other process. In some examples, photoselective plating is used to form the conductor layer 624 only at selected sensor locations such as at conductive pads, at conductive strips to serve as resistors, or at sensing elements that are to be suspended about the substrate. Photoselective plating of a conductor layer tends to eliminate or reduce the need for additional patterning of the conductor layer.

If a patterning process is not used to form the conductor layer 624 (or if additional patterning is intended) as determined at 605, the conductor layer 624 is patterned at 606 to form the sensing element 632 and/or conductive pads and resistors such as conductive pats 625, 626, 628 and resistor 630. In one example, patterning includes forming a layer of photoresist, patterning and developing the photoresist so that the photoresist protects portions of the conductor layer 624 that are associated with the sensing element and/or conductive pads and resistors. The unprotected areas of the conductor layer are then removed using a wet or dry etching process, such as a plasma etch or an acid etch. After etching, the portions of the conductor layer that are associated with the sensing element and/or conductive pads and resistors remain as covered by the photoresist. Other portions of the conductor layer are removed. In some cases, the protective photoresist is removed at prior to removing the spacer layer that separates the sensing element from the substrate so that the sensing element is suspended above the substrate.

At 608, at least portions of the spacer layer situated between the sensing element and the substrate are removed to suspend the sensing element 632 above the substrate 620 to produce a sensor 640. Typically, a non-directional etch such as a wet etch is used to remove spacer layer portions beneath the sensing element 632 and the spacer layer 622 is removed from other areas of the substrate 620 except as protected by the remaining portions of the conductor layer 624. A wet etch generally removes some spacer layer underneath and at the edges of the remaining conductor layer 624. The sensing element 632 is generally narrow enough (or includes multiple narrow features) so that this undercutting suspends the sensing element while the spacer layer 622 remains underneath other features (such as pads).

In operation, sensing elements are heated, typically using resistive heating provided by a conductive strip having a suitable resistance. Higher temperatures can be associated with superior sensor performance, but these higher temperatures can also cause degradation of the sensing element as well as pads or other feature defined in the conductor layer. At 610, at least the sensing element is situated in an enclosure which is then filled and sealed at 612 with a non-reactive gas such as a noble gas, nitrogen, or other gas that tends to reduce oxidation or other degradation of the sensing element. The enclosure can be formed as a cavity defined about the sensor in an additional layer such as a flexible layer that forms a cavity wall 650 and is then covered with a cap layer.

### Example 7

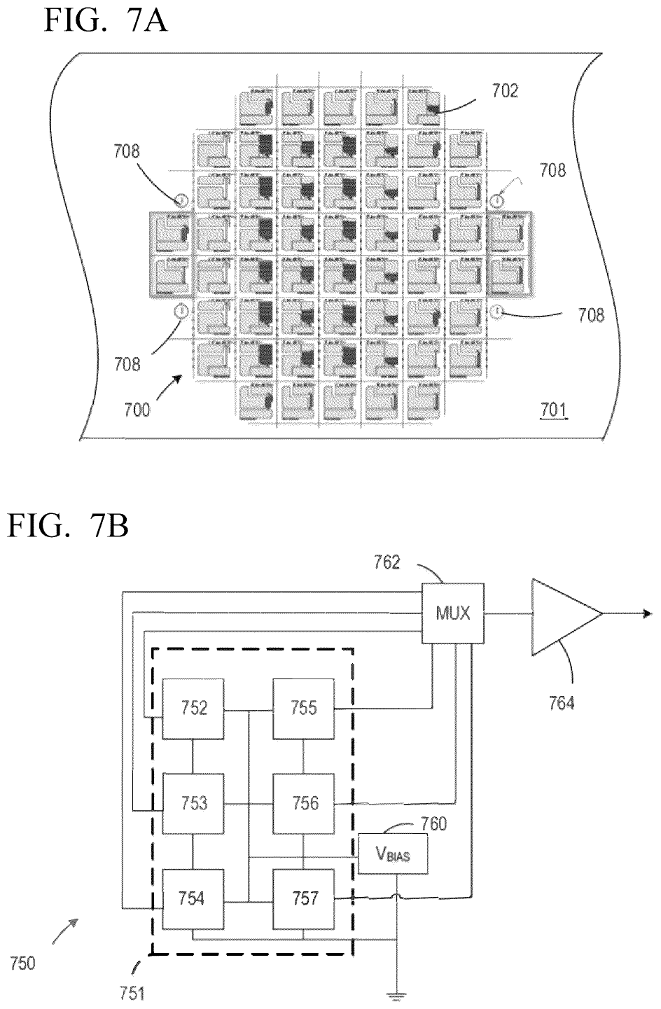

Referring to FIG. 7A, a representative array 700 of sensors such as sensor 702 is defined on a section 701 of a substrate roll. Each sensor of the array can have a different resistor conductor and sensing element. Alignment marks 708 are provided for use in patterning operations. The sensors can be separated for use individually, or some or all sensors of the sensor of the array 700 can be used together to provide the same or different sensitivities and/or the same of different bandwidths. Two or more sensors can be proved with a common configuration for redundancy.

FIG. 7B illustrates a sensor system 750 that includes a sensor array 751 having sensors 752-757. The sensor array 751 is shown as a rectangular array that includes multiple sensors on the same substrate or multiple sensors that can be distributed throughout an area of interest. As shown, each of the sensors 752-757 receives the same bias voltage VBIAS from a bias source 760 but different bias voltages can be supplied to some all of the sensors 752-757. Sensor outputs are coupled to a multiplexer (mux) 762 that can selectively deliver the output from a selected sensor to an amplifier 764 or other electronics such as filters, analog-to-digital convertors (ADCs), additional amplifiers, or other digital or analog circuits. A control circuit such as a microprocessor or other programmable logic device can be coupled to the mux 762 to enable selection of a sensor. In other examples, each sensor (or some sensors) are coupled to dedicated amplifiers or other electronics. In some alternatives, each of the sensors 752-757 is arranged to operate at a different frequency and the output signals from each of the sensors 752-757 can be combined in a single output and distinguished based on signal frequency. In addition, each of the sensors 752-757 can be associated with a particular location so that signals identify locations at which acoustic signals are present.

### Example 8

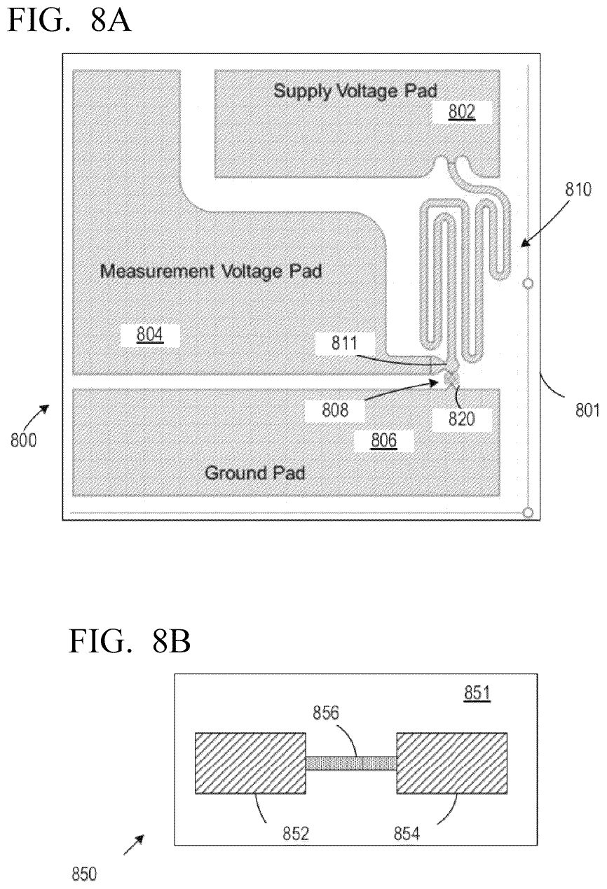

Referring to FIG. 8A, a sensor 800 includes conductive pads 802, 804, 806 situated on a substrate 801. In FIG. 8A, the pads are referred to as a supply voltage pad, a measurement voltage pad, and a ground pad, respectively, for convenient description of a representative circuit arrangement for use with the sensor 800. A resistor element 810 extends from the pad 802 to electrically connect to the pad 804 at a conductive connection 811. A sensing element 808 includes a first end that is electrically coupled to the conductive connection 811 and a second end that is electrically coupled to the pad 806. The sensing element 808 is spaced apart from the substrate 801 in a region 820 and the first end and the second end of the sensing element 808 are fixed to the substrate 801. In this example, the resistor element 810 is formed as a serpentine strip defined in a conductive layer.

As shown in FIG. 8B, a sensor 850 can have a sensing element 856 that is suspended between contact pads 852, 854 above a substrate 851. The contact pads 852, 854 and the sensing element 856 can be of different materials, and if an integrated resistor were provided, the same or different materials can be used. For example, the sensing element 856 can be made of material having large resistivity changes with temperature or that does not degrade when heated, while materials for pads and resistors can be selected for ease of fabrication, bonding, patterning, or to provide a selected resistance.

### Example 9

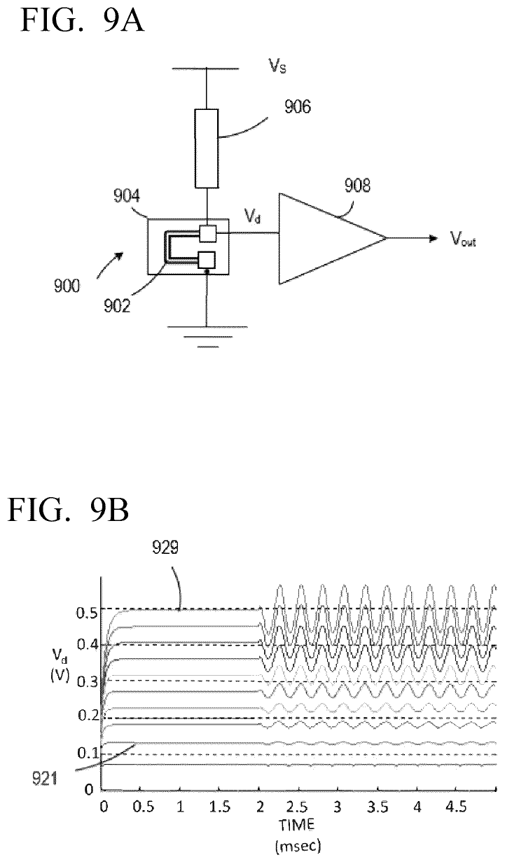

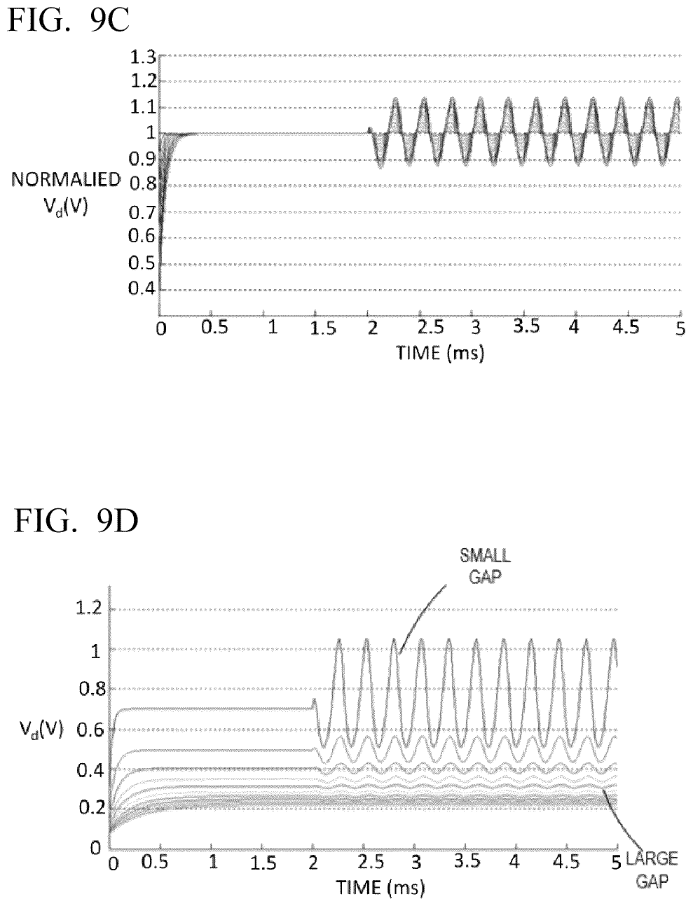

Referring to FIG. 9A, a representative sensor system 900 includes a sensing element 902 suspended above a substrate 904. A power supply provides a voltage V_{S} that is applied to the sensing element 902 via a resistor 906 that can be a discrete component or defined in one or more layers situated on the substrate 904. An amplifier 908 is coupled to the sensing element 902 and receives a voltage V_{d} responsive to movement of the sensing element 902. Based on this voltage, the amplifier produces an output voltage Vₒᵤₜ. The resistor 906 can also establish a current in the sensing element 902 that heats the sensing element 902 but heating can be provided in other ways as well.

FIG. 9B illustrates sensor voltage V_{d} associated with a nominal sensing element oscillation of about 100 nm in a 1 μm gap. Curve 921 is associated with a lowest applied voltage V (and lowest heating of the sensing element 902) and curve 929 is associated with a largest applied voltage V (and largest heating of the sensing element 902). The curves situated between the curve 921 and 929 are arranged in order of increasing applied voltage V_{S} (and thus increasing sensor element temperature). The curves of FIG. 9B illustrate sensor response as a function of time. At 0 ms, the voltage V_{S} is applied and at about 2 ms, vibration of the sensing element 902 is initiated. The initial voltage rise prior to 2 ms is associated with stabilization of the sensing element 902 at the chosen applied voltage. The sensing element voltage oscillations in curve 929 are larger those in the curve 921 due to the larger applied voltage V_{S} and the resulting higher temperature of the sensing element 902. While higher temperatures produce larger output signals, sensing element temperature is limited as melting must be avoided and long-term use of higher temperatures can result in sensing element oxidation. For this reason, in some examples, sensing elements are situated in inert gas filled container, for example, an argon filled container. FIG. 9C illustrates normalized sensor response V_{d} for a variety of sensing element temperatures, corresponding to FIG. 9B. Larger normalized amplitudes of oscillation are associated with higher temperatures and illustrates the advantage of higher temperatures.

FIG. 9D illustrates sensor response to a nominal 100 nm oscillation for gaps in a range of about 500 nm to about 5 μm. Larger amplitudes of oscillation are associated with smaller gaps. While the applied voltage V_{S} is varied in this example, the values of the value of resistor 906 can likewise be varied to cause changes in temperature and sensor response V_{d}.

### Example 10

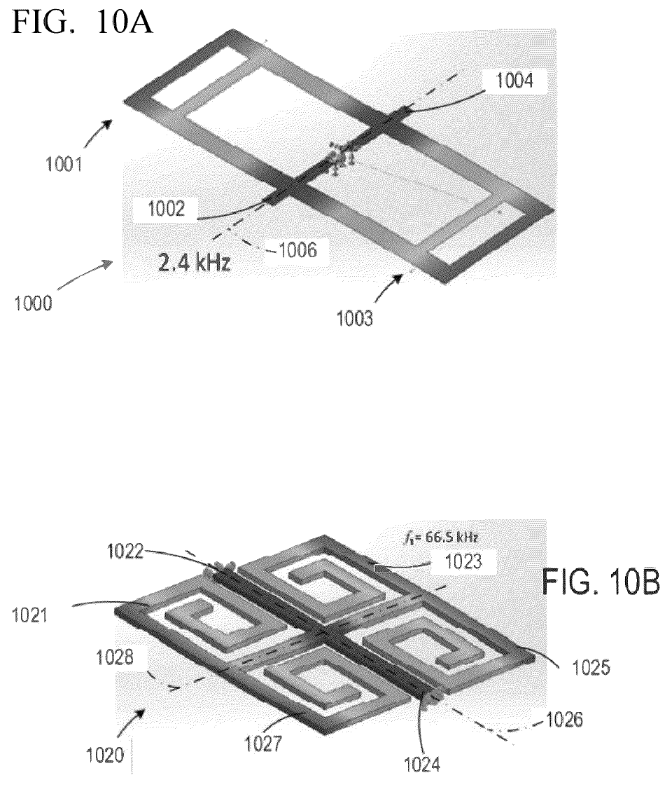

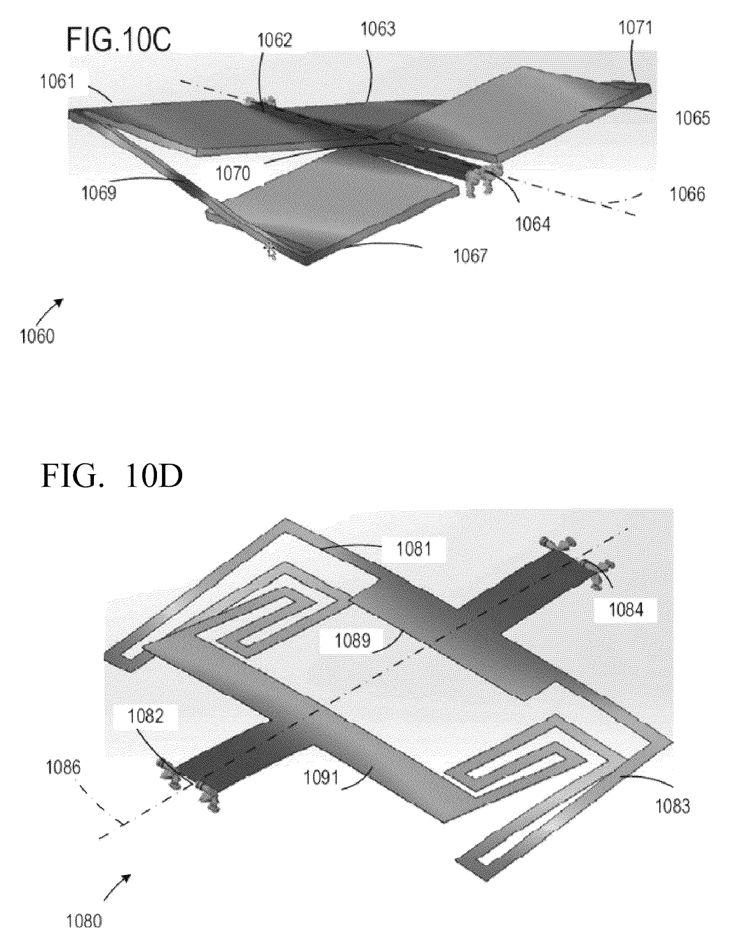

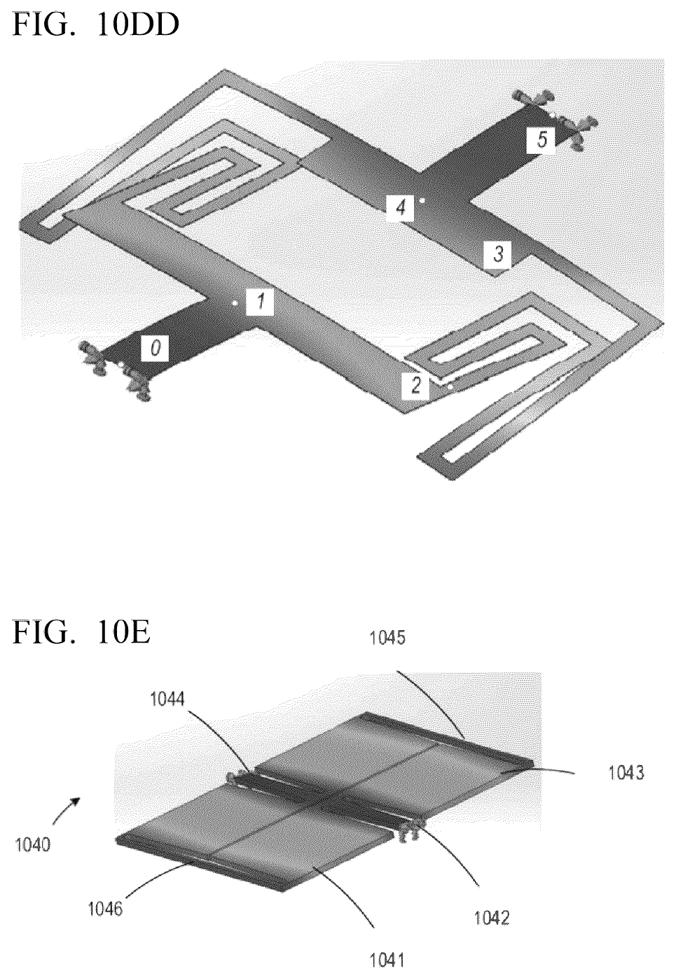

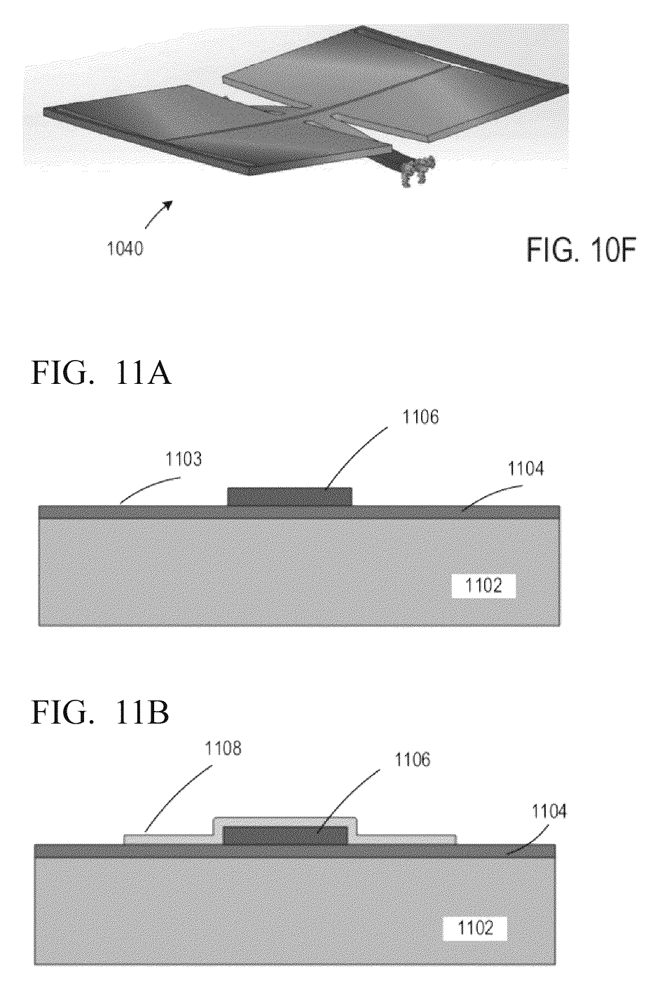

FIGS. 10A-10E illustrate additional sensing elements. In some of these examples, the sensing elements are shown as deformed in response to acoustic signals. In these examples, sensing elements are symmetric about one or more axes, but in other examples, sensing elements lack such symmetry. A sensing element 1000 as shown in FIG. 10A includes fixed ends 1002, 1004 that are used for sensing element suspension as well as to make electrical connections. The sensing element 1000 includes conductor sections 1001, 1003 that are symmetric about an axis 1006 that extends between the fixed ends 1002, 1004. Relatively high damping and low Q are associated with this example and a detectable frequency range can be at least 2.2 kHz to 10 kHz, starting slightly below a lowest order mode frequency.

FIG. 10B illustrates a sensing element 1020 that includes fixed ends 1022, 1024 that are used for sensing element suspension as well as to make electrical connections. The sensing element 1020 includes conductor quadrants 1021, 1023, 1025, 1027 shaped as rectangular spirals that are symmetric about an axis 1026 that extends between the fixed ends 1022, 1024 and perpendicular axis 1028 that is situated between the conductor quadrants 1021, 1023, and the conductor quadrants 1025, 1027. In this example, high damping and low Q are expected and a detectable frequency range can be at least 60-70 kHz This example is intended for applications with a transducer emitting sound above a human hearing range and at a first mode frequency of 67 kHz.

FIG. 10C illustrates a sensing element 1060 that includes fixed ends 1062, 1064 of a central strip 1070 that are used for sensing element suspension as well as to make electrical connections. The sensing element 1060 includes conductor quadrants 1061, 1063, 1065, 1067 shaped as rectangular plates connected with perimeter conductor strips such as strips 1069, 1071. The conductor quadrants 1061, 1063, 1065, 1067 are symmetric about an axis 1066 that extends between the fixed ends 1062, 1064 and a perpendicular axis (not shown in FIG. 10C) that is situated between the conductor quadrants 1061, 1063, and the conductor quadrants 1065, 1067. The strips 1069, 1071 increase resistance and this arrangement places the increased resistance at a sensing element region that is associated with a large vibrational amplitude. In example, a lowest order mode frequency is 12.4 kHz. Given that this example exhibits high damping and low Q, a useful frequency range can be least 12 kHz to 30 kHz or higher. Some modes may be less suited for cooling due to the direction of motion associated with the mode, but numerous modes are available. Sensor element dimensions are relatively large at 500 μm by 500 μm.

FIG. 10D illustrates a sensing element 1080 similar to that of FIGS. 1A-1B that includes fixed ends 1082, 1084 that are used for sensing element suspension as well as to make electrical connections. The sensor 1080 includes conductor sections 1081, 1083 shaped generally as rectangular spirals connected to end conductor strips such as strips 1089, 1091. The conductor sections 1081, 1083 are symmetric about an axis 1086 that extends between the fixed ends 1082, 1084. FIG. 10DD shows locations 0-5 associated with path resistances at 400° C., 200° C., and 25° C. in the following table. of 0.48 Ω, 0.35 Ω, 6.95 Ω, 0.21Ω, and 0.48Ω on paths 0-1, 1-2, 2-3, 3-4, and 4-5, respectively, in one example. The largest resistance (2-3) is generally associated with larger vibrational amplitudes, improving sensing element response.

| Resistance | | | |
|---|---|---|---|
| (Ω) | Temperature (° C.) | | |
| Path | 25 | 200 | 400 |
| 0-1 | .29 | .48 | .72 |
| 1-2 | .21 | .35 | .52 |
| 2-3 | 4.22 | 6.95 | 10.36 |
| 3-4 | .12 | .21 | .32 |
| 4-5 | .29 | .48 | .71 |
| Total | 5.1 | 8.4 | 12.5 |

FIG. 10E illustrates a sensing element 1040 (similar to that of FIG. 10C) that includes fixed ends 1042, 1044 that are used for sensing element suspension as well as to make electrical connections. The sensing element 1040 includes conductor sections 1041, 1043 shaped that are rectangular connected to end conductor strips such as strips 1045, 1046. The conductor sections 1041, 1043 are symmetric about an axis that extends between the fixed ends 1042, 1044. FIG. 10F illustrates a representative vibrational mode of the sensing element 1040. The strips 1045, 1046 increase resistance and this arrangement places the increased resistance at a sensing element region that is associated with a large vibrational amplitude. In FIGS. 10A-10E above, the detectable ranges of acoustic waves differ because the resonance frequencies differ.

### Example 11

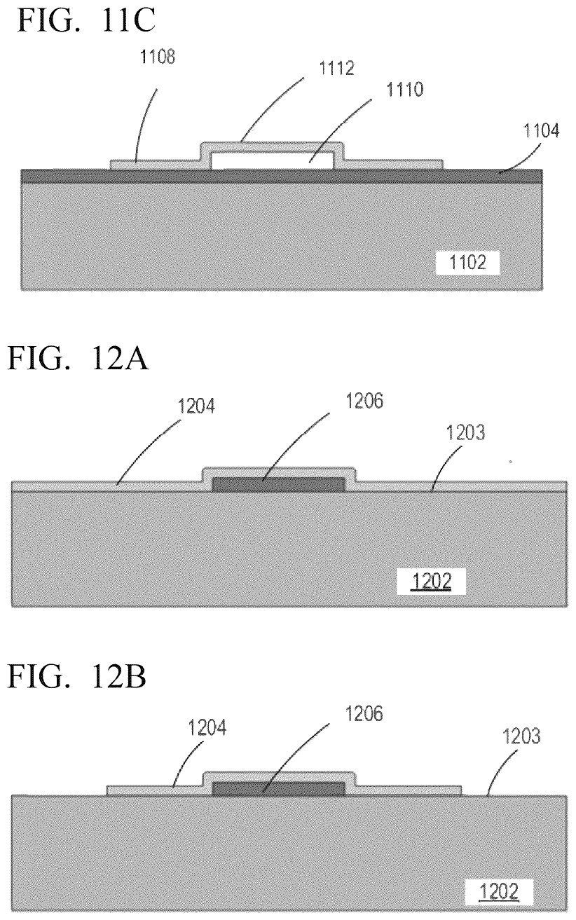

FIGS. 11A-11C illustrate another representative method of making the disclosed sensors. As shown in FIG. 11A, a photoresist spacer 1106 is applied to a protective layer such as an oxide layer 1104 formed on a substrate 1102. The photoresist spacer 1106 can be produced by patterning a photoresist layer that is applied generally to a surface 1103 of the protective layer 1104. As shown in FIG. 11B. a conductor layer 1108 is deposited on the photoresist spacer 1106 and portions of the surface 1103. As shown in FIG. 11C, the photoresist spacer 1106 is removed and a sensing element is formed by a bridged portion 1112 of the conductor layer 1108 and a gap 1110 produced by removal of the photoresist. The photoresist spacer 1106 can be removed with a solvent in liquid or vapor form, such as acetone as a liquid or a vapor.

### Example 12

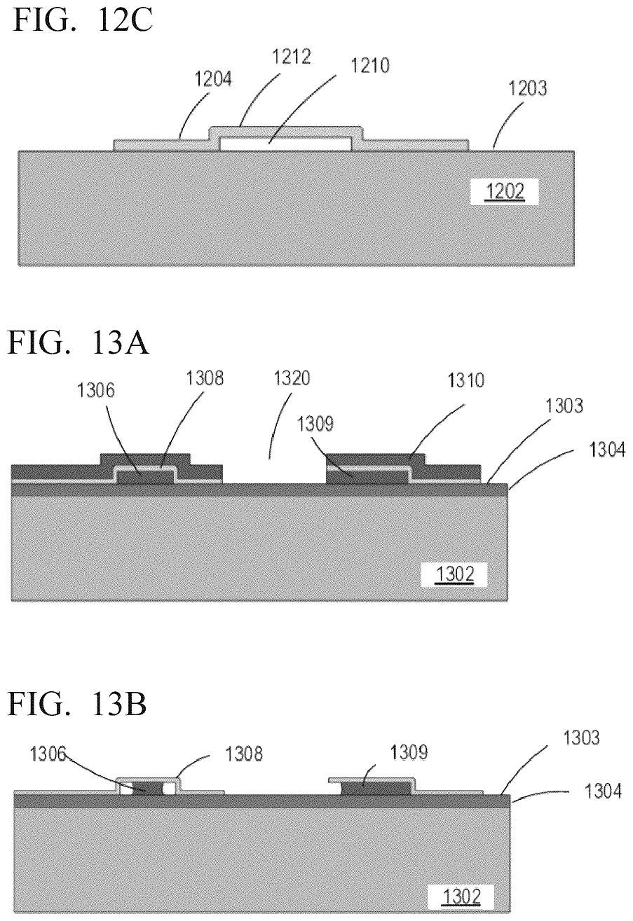

FIGS. 12A-12C illustrate another representative method of making the disclosed sensors. As shown in FIG. 12A, an oxide spacer 1206 is formed on a surface 1203 of a substrate 1202 and a conductor layer 1204 is deposited on the oxide spacer 1206 and the surface 1203. The oxide spacer 1206 can be produced by patterning an oxide layer using a patterned photoresist layer and a suitable etching process. As shown in FIG. 12B, portions of the conductor layer 1204 situated away from the oxide spacer 1206 are removed. As shown in FIG. 12C, the oxide spacer 1206 is removed and a sensing element is formed by a bridged portion 1212 of the conductor layer 1204 and a gap 1210 produced by removal of the oxide spacer 1206. For silicon substrates and silicon dioxide spacer, the oxide spacer 1206 can be removed with HF vapor or a buffered oxide etch (BOE) of HF and a buffer. These etches tend to remove silicon dioxide but do not etch silicon. Other etching approaches can used, and spacers other than silicon dioxide may require different etchants.

### Example 13

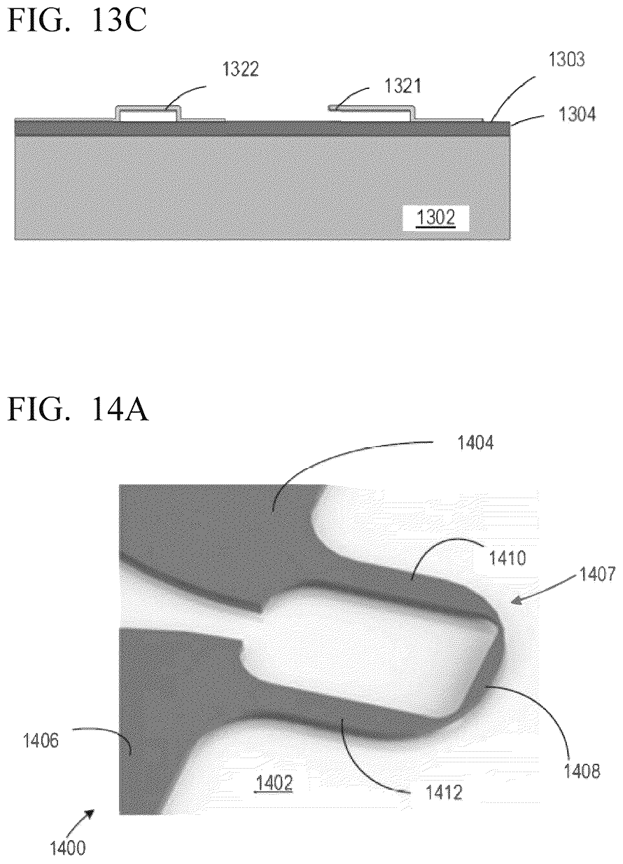

FIGS. 13A-13C illustrate another representative method of making the disclosed sensors. As shown in FIG. 13A, a conductor layer 1308 is formed on photoresist spacers 1306, 1309 on a surface 1303 of an oxide layer 1304 on a substrate 1302. A photoresist layer 1310 is formed on the conductor layer 1308 and patterned to remove portions of the conductor layer 1308 in a gap 1320. FIG. 13B shows removal of the photoresist layer 1310 and partial removal of the photoresist spacers 1306, 1309 with a wet solvent etch. The remaining portions of the photoresist spacers 1306, 1309 are protected by the conductor layer 1308 and a solvent vapor etch is used to produce the structure shown in FIG. 13C. Electrically separate sensing elements 1321, 1322 are suspended above the substrate 1302. The sensing element 1322 is fixed at two ends while the sensing element 1321 is fixed at only one end.

### Example 14

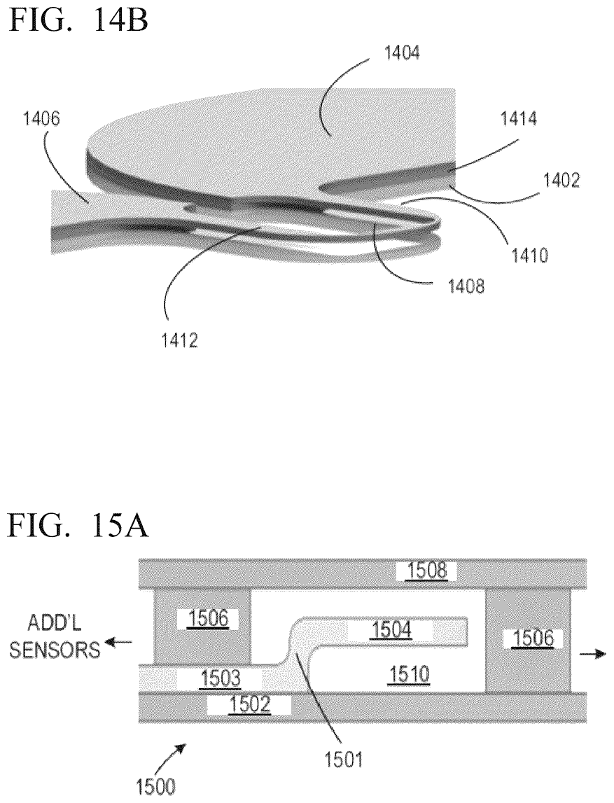

FIGS. 14A-14B illustrate a representative sensor 1400 that includes a substrate 1402 and conductors 1404, 1406 that are fixed to the substrate 1402. A sensing element 1407 includes first and second conductive extensions 1410, 1412 and a connecting conductor 1408, all of which are suspended above the substrate 1402. A spacer layer 1414 separates the conductors 1404, 1406 from the substrate 1402, but the spacer layer 1414 is not underneath the extensions 1410, 1412, or the connector 1408. The spacer layer 1414 is typically undercut by removal of spacer material beneath the extensions 1410, 1412 and the connector 1408.

### Example 15

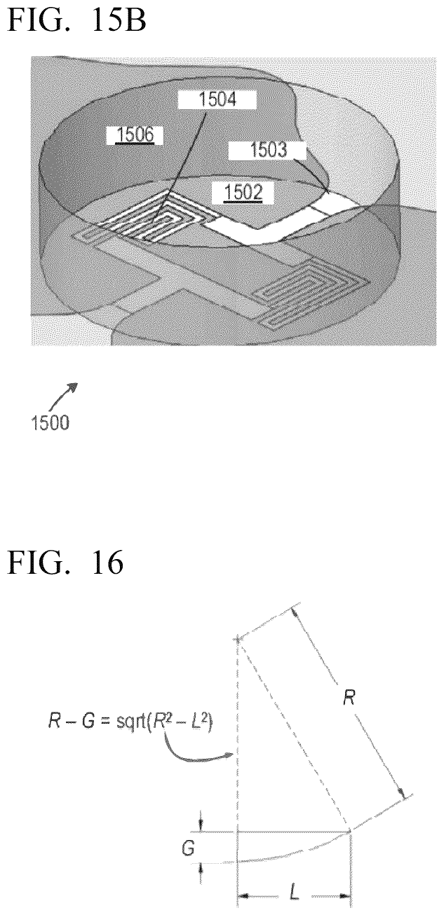

Referring to FIGS. 15A-15B, a representative sensor 1500 includes a sensor conductor 1501 that includes a portion 1503 that is fixed to a substrate 1502 and a conductive sensing element 1504 that is suspended from the substrate 1502. The conductive sensing element 1504 is situated in an enclosure volume 1510 of an enclosure defined by the substrate 1502, a cap layer 1508, and an enclosure wall 1506 that extends from the substrate 1502. A plurality of sensors can be formed using a single substrate and a single cap layer, with each sensor situated in a respective enclosure. Sensors of such a plurality can have the same or different configurations of sensing elements, bias resistors, enclosure volumes, or other specifications.

### Example 16

The disclosed sensors can be provided on a substrate that can be rolled or bent but there are limits to bending radii of curvature. Referring to FIG. 16, a possible minimum radius of curvature R for a sensor of length L having a gap G can be expressed as

$$R = \frac{{L}^{2} + {G}^{2}}{2 G} .$$

This minimum radius of curvature is associated with contact of a sensing conductor and a substrate—with smaller radii of curvature, a sensing conductor would contact the substrate which is generally undesirable. Some substrate or sensing element materials may not permit the minimum radius of curvature determined above due to yield, fatigue, or material properties and R must be larger.

### Example 17

The disclosed sensors typical sample vibrations at about 10 Hz to 100 Hz but are responsive to input signals of up to 1 MHz or more, depending on sensing element configuration. Resonance modes of the sensing elements act as frequency filters so that a range of frequencies near sensing element resonance frequencies can be sampled. For example, with a 1 μm air-gap and vibration damping due to the thin sensing element, the sensing elements serve as filters with low Q and sense in a wide bandwidth. The sensing elements typically average the effects of motion around resonance frequencies through cooling of the sensing element. The detected signals produced with the sensing elements do not correspond precisely to either a frequency or Fourier domain response because the relationship between the cooling and vibration amplitude is non-linear. Nevertheless, such response is suitable for many applications.

Referring to FIGS. 17A, average thermal conductivity for a sensing element 1704 having a gap G to a substrate 1702 defined by a spacer 1706 is proportional to 1/G. As an example, assume that the gap G=1 μm. If the sensing element 1704 is subjected to a square wave acoustic signal so that the gap G alternates between 0.5 μm and 1.5 μm, then the average conductivity is proportional to the average of (0.5 μm)⁻¹ and (1.5 μm)⁻¹ or 4/3/μm, which is greater than the conductivity associated with the stationary sensing element 1704. Conductivity as a function of time in response to a sinusoidal vibration is shown in FIG. 17B, wherein curve 1752 corresponds to a stationary sensing element and curve 1754 corresponds to a vibrating sensor element. It is apparent that average conductivity in response to periodic signals is greater than conductivity of a stationary sensing element. It can be shown that average conductivity in response to a sinusoidal input tends to approach A/\sqrt{G²−SG²}, wherein A is a constant and SG is the amplitude of the sensing element oscillation.

### Illustrative Examples

Example 1 is a sensor, including: a substrate; a sensing element secured to the substrate at at least one end so that the sensing element is spaced apart from the substrate; and a sensor circuit coupled to the sensing element and operable to heat the sensing element and produce an output signal associated with vibrations of the sensing element.

Example 2 includes the subject matter of Example 1, and further specifies that the output signal associated with the vibrations of the sensing element corresponds to changes in temperature of the sensing element.

Example 3 includes the subject matter of any of Examples 1-2, and further specifies that the sensing element is secured to the substrate at a first end and a second end so that the sensing element extends from the first end to the second end and is suspended from the substrate.

Example 4 includes the subject matter of any of Examples 1-3, and further includes a spacer situated at the at least one end of the sensing element to define a gap between the sensing element and the substrate.

Example 5 includes the subject matter of any of Examples 1-4, and further specifies that the substrate is a flexible substrate.

Example 6 includes the subject matter of any of Examples 1-5, and further specifies that the substrate is polyethylene terephthalate.

Example 7 includes the subject matter of any of Examples 1-6, and further specifies that the sensing element is a metal.

Example 8 includes the subject matter of any of Examples 1-7, and further includes a resistive conductor coupled to the sensing element, wherein the sensor circuit is operable to heat the sensing element with a current conducted by the resistive conductor to the sensing element.

Example 9 includes the subject matter of any of Examples 1-8, and further includes at least one conductive pad defined on the substrate, wherein the conductive pad and the sensing element are defined in a common conductive layer.

Example 10 includes the subject matter of any of Examples 1-9, and further includes at least one conductive pad defined on the substrate, wherein the at least one conductive pad and the sensing element are defined by different materials.

Example 11 includes the subject matter of any of Examples 1-10, and further specifies that the at least one conductive pad comprises first, second, and intermediate conductive pads, and a resistor is defined in the common conductive layer, and the sensing element is coupled to the first conductive pad by the resistor and fixed to the substrate at the second conductive pad.

Example 12 includes the subject matter of any of Examples 1-11, and further includes a spacer situated between the first, second, and intermediate conductive pads, and the resistor, wherein the sensing element is spaced apart from the substrate by a gap associated with a spacer thickness.

Example 13 includes the subject matter of any of Examples 1-12, and further specifies that the resistor comprises a serpentine strip defined in the same conductive layer.

Example 14 includes the subject matter of any of Examples 1-13, and further specifics that the at least one end includes a first end and a second end, and the sensing element is secured to and spaced apart from the substrate at the first end and the second end.

Example 15 includes the subject matter of any of Examples 1-14, and further includes an enclosure situated about at least the sensing element.

Example 16 includes the subject matter of any of Examples 1-15, and further specifics that the enclosure is filled with an inert gas.

Example 17 includes the subject matter of any of Examples 1-16, and further specifies that the enclosure includes an enclosure wall that extends from the substrate and a cap layer sealed to the enclosure wall and defining an enclosure volume.

Example 18 is a method, including: forming a conductive layer coupled to a substrate; and patterning the conductive layer to define a conductive sensing element spaced apart from the substrate, wherein a first fixed end and a second fixed end of the conductive sensing element are secured to the substrate.

Example 19 includes the subject matter of Example 18, and further specifies that the conductive layer is formed on a spacer layer, and the conductive sensing element is spaced-apart from the substrate by removing a portion of the spacer layer.

Example 20 includes the subject matter of any of Examples 18-19, and further includes forming a spacer layer on the substrate at a location associated with the conductive sensing element, wherein the conductive layer is formed on an exposed portion of the substrate and the spacer layer; and removing the spacer layer so that the conductive sensing element is spaced-apart from the substrate.

Example 21 includes the subject matter of any of Examples 18-20, and further includes defining a resistor in the conductive layer, wherein the resistor is operable to heat the conductive sensing element.

Example 22 includes the subject matter of any of Examples 18-21, and further specifies that the resistor is defined as a serpentine conductive strip.

Example 23 includes the subject matter of any of Examples 18-22, and further specifies that the conductive sensing element includes a plurality of segments that are symmetric about an axis.

Example 24 is a sensor array, including: a substrate; a plurality of sensors defined on the substrate, each of the plurality of sensors including a sensing element; and at least one spacer coupled to the sensing element of each of the plurality of sensors and the substrate to define a gap between the sensing elements and the substrate.

Example 25 includes the subject matter of Example 24, and further specifies that the sensing element and the at least one spacer of each of the sensing elements is defined in the same conductive layer and the same spacer layer, respectively.

Example 26 includes the subject matter of any of Examples 24-25, and further specifies that each sensor of the plurality of sensors further includes: first, second, and intermediate conductive pads defined in the same conductive layer and coupled to the sensing element; and a resistor defined in the same conductive layer and coupled to the sensing element and a selected one of the first, second, and intermediate conductive pads.

Example 27 includes the subject matter of any of Examples 24-27, and further specifies that the substrate is a flexible substrate.

Example 28 includes the subject matter of any of Examples 24-26, and further specifies that at least some resistor of the sensors have different shapes and at least some sensing elements of the sensors have different shapes.

In view of the many possible embodiments to which the principles of the disclosed technology may be applied, it should be recognized that the illustrated embodiments are only preferred and should not be taken as limiting the scope of the disclosure. I claim as my invention all that comes within the scope of the appended claims.

What is claimed is:

1. A sensor, comprising:
a substrate;
a sensing element secured to the substrate at least one end so that the sensing element is spaced apart from the substrate; and
a sensor circuit coupled to the sensing element and operable to heat the sensing element and produce an output signal associated with vibrations of the sensing element.

2. The sensor according to claim 1, wherein the output signal associated with the vibrations of the sensing element corresponds to changes in temperature of the sensing element.

3. The sensor according to claim 1, wherein the sensing element is secured to the substrate at a first end and a second end so that the sensing element extends from the first end to the second end and is suspended from the substrate.

4. The sensor circuit according to claim 1, further comprising a spacer situated at the at least one end of the sensing element to define a gap between the sensing element and the substrate.

5. The sensor according to claim 1, wherein the substrate is a flexible substrate.

6. The sensor according to claim 1, wherein the substrate is polyethylene terephthalate.

7. The sensor according to claim 1, wherein the sensing element is a metal.

8. The sensor according to claim 1, further comprising a resistive conductor coupled to the sensing element, wherein the sensor circuit is operable to heat the sensing element with a current conducted by the resistive conductor to the sensing element.

9. The sensor according to claim 1, further comprising at least one conductive pad defined on the substrate, wherein the conductive pad and the sensing element are defined in a common conductive layer.

10. The sensor according to claim 1, further comprising at least one conductive pad defined on the substrate, wherein the at least one conductive pad and the sensing element are defined by different materials.

11. The sensor according to claim 9, wherein the at least one conductive pad comprises first, second, and intermediate conductive pads, and a resistor is defined in the common conductive layer, and the sensing element is coupled to the first conductive pad by the resistor and fixed to the substrate at the second conductive pad.

12. The sensor according to claim 11, further comprising a spacer situated between the first, second, and intermediate conductive pads, and the resistor, wherein the sensing element is spaced apart from the substrate by a gap associated with a spacer thickness.

13. The sensor according to claim 12, wherein the resistor comprises a serpentine strip defined in the same conductive layer.

14. The sensor according to claim 1, wherein the at least one end includes a first end and a second end, and the sensing element is secured to and spaced apart from the substrate at the first end and the second end.

15. The sensor according to claim 1, further comprising an enclosure situated about at least the sensing element.

16. The sensor according to claim 15, wherein the enclosure is filled with an inert gas.

17. The sensor according to claim 16, wherein the enclosure includes an enclosure wall that extends from the substrate and a cap layer sealed to the enclosure wall and defining an enclosure volume.

18. A method, comprising:
forming a conductive layer coupled to a substrate; and
patterning the conductive layer to define a conductive sensing element spaced apart from the substrate, wherein a first fixed end and a second fixed end of the conductive sensing element are secured to the substrate.

19. The method according to claim 18, wherein the conductive layer is formed on a spacer layer, and the conductive sensing element is spaced-apart from the substrate by removing a portion of the spacer layer.

20. The method according to claim 18, further comprising:
forming a spacer layer on the substrate at a location associated with the conductive sensing element, wherein the conductive layer is formed on an exposed portion of the substrate and the spacer layer; and
removing the spacer layer so that the conductive sensing element is spaced-apart from the substrate.

21. The method according to claim 18, further comprising defining a resistor in the conductive layer, wherein the resistor is operable to heat the conductive sensing element.

22. The method according to claim 21, wherein the resistor is defined as a serpentine conductive strip.

23. The method according to claim 18, wherein the conductive sensing element includes a plurality of segments that are symmetric about an axis.

24. A sensor array, comprising:
a substrate;
a plurality of sensors defined on the substrate, each of the plurality of sensors including a sensing element; and
at least one spacer coupled to the sensing element of each of the plurality of sensors and the substrate to define a gap between the sensing elements and the substrate.

25. The sensor array according to claim 24, wherein the sensing element and the at least one spacer of each of the sensing elements is defined in the same conductive layer and the same spacer layer, respectively.

26. The sensor array according to claim 24, wherein each sensor of the plurality of sensors further includes:
first, second, and intermediate conductive pads defined in the same conductive layer and coupled to the sensing element; and
a resistor defined in the same conductive layer and coupled to the sensing element and a selected one of the first, second, and intermediate conductive pads.

27. The sensor array according to claim 24, wherein the substrate is a flexible substrate.

28. The sensor array according to claim 26, wherein at least some resistor of the sensors have different shapes and at least some sensing elements of the sensors have different shapes.
